(19) United States
(12) Patent Application Publication
(10) Pub. No.: US 2024/0355356 A1
(43) Pub. Date: Oct. 24, 2024

(54) MAGNETIC RECORDING MEDIUM, MAGNETIC TAPE CARTRIDGE, AND MAGNETIC RECORDING AND REPRODUCING DEVICE

(71) Applicant: FUJIFILM CORPORATION, Tokyo (JP)

(72) Inventors: Wataru KIKUCHI, Minamiashigara-shi (JP); Nobuhito ONOZUKA, Minamiashigara-shi (JP)

(73) Assignee: FUJIFILM CORPORATION, Tokyo (JP)

(21) Appl. No.: 18/644,255

(22) Filed: Apr. 24, 2024

(30) Foreign Application Priority Data
Apr. 24, 2023 (JP) 2023-070782

(51) Int. Cl. G11B 5/735; G11B 5/73; G11B 5/78

(52) U.S. Cl. CPC G11B 5/7358; G11B 5/73923; G11B 5/78

(57) ABSTRACT

The magnetic recording medium includes a non-magnetic support; and a magnetic layer containing a ferromagnetic powder, in which a nitrogen-containing polymer is included in a portion on the non-magnetic support on a magnetic layer side, the nitrogen-containing polymer contains a fluorine-containing group and a polyester chain, the fluorine-containing group is bonded to a nitrogen atom of the nitrogen-containing polymer, the polyester chain is bonded to the nitrogen atom of the nitrogen-containing polymer or forms a salt crosslinking structure with the nitrogen atom of the nitrogen-containing polymer, and a contact angle with water, which is measured on a surface of the magnetic layer after hexane cleaning, is 90° or more.

### CROSS-REFERENCE TO RELATED APPLICATIONS

This application claims priority under 35 U.S.C 119 to Japanese Patent Application No. 2023-070782 filed on Apr. 24, 2023. The above application is hereby expressly incorporated by reference, in its entirety, into the present application.

### BACKGROUND OF THE INVENTION

### 1. Field of the Invention

The present invention relates to a magnetic recording medium, a magnetic tape cartridge, and a magnetic recording and reproducing device.

### 2. Description of the Related Art

The magnetic recording medium is generally manufactured by forming a magnetic layer containing a ferromagnetic powder and any one or more kinds of additives on a non-magnetic support. For example, in Examples of JP2017-157252A, the magnetic layer is formed by using a composition for forming a magnetic layer including a polyalkyleneimine-based polymer together with the ferromagnetic powder.

### SUMMARY OF THE INVENTION

Recording of data on the magnetic recording medium and reproducing of recorded data are usually performed as the magnetic recording medium is run in the magnetic recording and reproducing device and a magnetic layer surface of the magnetic recording medium and a magnetic head come into contact with each other to be slid on each other. In a case where a foreign substance adheres to the magnetic head due to sliding on the magnetic layer surface, an interval between the magnetic layer surface and the magnetic head is widened because of the presence of the foreign substance, and as a result, an output variation, which is called a spacing loss, may occur. Therefore, it is desirable that the magnetic layer surface exhibits abrasiveness, and the foreign substance adhering to the magnetic head can be removed by abrasion during sliding on the magnetic layer surface, because the spacing loss can be reduced. On the other hand, in a case where the abrasiveness of the magnetic layer surface is too high, the magnetic head itself is abraded. Therefore, it is desired that the magnetic layer surface exhibits appropriate abrasiveness.

In addition, it is desirable that a friction coefficient in a case of sliding between the magnetic layer surface and the magnetic head is low even after repeating the running of the magnetic recording medium, from the viewpoint of running stability. Further, it is desirable that a change in surface shape of the magnetic layer before and after the repeated running is small, from the viewpoint of maintaining the abrasiveness of the magnetic layer surface.

An object of one aspect of the present invention is to provide a magnetic recording medium having a magnetic layer surface capable of exhibiting appropriate abrasiveness, in which a low friction coefficient can be exhibited even after repeated running and a change in surface shape of the magnetic layer before and after the repeated running is small.

One aspect of the present invention is as follows.

[1] A magnetic recording medium comprising: a non-magnetic support; and a magnetic layer containing a ferromagnetic powder, in which a nitrogen-containing polymer (hereinafter, referred to as a “fluorine-based nitrogen-containing polymer”) is included in a portion on the non-magnetic support on a magnetic layer side, the nitrogen-containing polymer contains a fluorine-containing group and a polyester chain, the fluorine-containing group is bonded to a nitrogen atom of the nitrogen-containing polymer, the polyester chain is bonded to the nitrogen atom of the nitrogen-containing polymer or forms a salt crosslinking structure with the nitrogen atom of the nitrogen-containing polymer, and a contact angle with water, which is measured on a surface of the magnetic layer after hexane cleaning, is 90° or more.

[2] The magnetic recording medium according to [1], in which the nitrogen-containing polymer is a polyalkyleneimine-based polymer.

[3] The magnetic recording medium according to [1] or [2], in which the fluorine-containing group includes a group selected from the group consisting of a fluorinated alkyl group and a perfluoropolyether group.

[4] The magnetic recording medium according to [3], in which the fluorinated alkyl group is a fluorinated alkyl group having 1 or more and 6 or less carbon atoms.

[5] The magnetic recording medium according to any one of [1] to [4], in which the contact angle is 90° or more and 110° or less.

[6] The magnetic recording medium according to any one of [1] to [5], in which the portion on the non-magnetic support on a magnetic layer side further includes one or more fatty acid compounds selected from the group consisting of a fatty acid, a fatty acid ester, and a fatty acid amide.

[7] The magnetic recording medium according to any one of [1] to [6], in which the portion on the non-magnetic support on a magnetic layer side further includes a nitrogen-containing polymer other than the nitrogen-containing polymer.

[8] The magnetic recording medium according to any one of [1] to [7], further comprising: a non-magnetic layer containing a non-magnetic powder between the non-magnetic support and the magnetic layer.

[9] The magnetic recording medium according to any one of [1] to [8], further comprising: a back coating layer containing a non-magnetic powder on a surface side of the non-magnetic support opposite to a surface side having the magnetic layer.

[10] The magnetic recording medium according to any one of [1] to [9], in which the magnetic recording medium is a magnetic tape.

[11] The magnetic recording medium according to any one of [1] to [10], in which the nitrogen-containing polymer is a polyalkyleneimine-based polymer, the fluorine-containing group includes a group selected from the group consisting of a fluorinated alkyl group and a perfluoropolyether group, the fluorinated alkyl group is a fluorinated alkyl group having 1 or more and 6 or less carbon atoms, the contact angle is 90° or more and 110° or less, the portion on the non-magnetic support on a magnetic layer side further includes one or more fatty acid compounds selected from the group consisting of a fatty acid, a fatty acid ester, and a fatty acid amide, and a nitrogen-containing polymer other than the nitrogen-containing polymer, the magnetic recording medium further includes a non-magnetic layer containing a non-magnetic powder between the non-magnetic support and the magnetic layer, and a back coating layer containing a non-magnetic powder on a surface side of the non-magnetic support opposite to a surface side having the magnetic layer, and the magnetic recording medium is a magnetic tape.

[12] A magnetic tape cartridge comprising: the magnetic tape according to or [11].

[13] A magnetic recording and reproducing device comprising: the magnetic recording medium according to any one of [1] to [11].

According to one aspect of the present invention, it is possible to provide a magnetic recording medium having a magnetic layer surface capable of exhibiting appropriate abrasiveness, in which a low friction coefficient can be exhibited even after repeated running and a change in surface shape of the magnetic layer before and after the repeated running is small. In addition, according to one aspect of the present invention, it is possible to provide a magnetic tape cartridge and a magnetic recording and reproducing device including the magnetic recording medium.

### DESCRIPTION OF THE PREFERRED EMBODIMENTS

### Magnetic Recording Medium

One aspect of the present invention relates to a magnetic recording medium including a non-magnetic support, and a magnetic layer containing a ferromagnetic powder. The magnetic recording medium includes a nitrogen-containing polymer in a portion on the non-magnetic support on a magnetic layer side, the nitrogen-containing polymer contains a fluorine-containing group and a polyester chain, the fluorine-containing group is bonded to a nitrogen atom of the nitrogen-containing polymer, the polyester chain is bonded to the nitrogen atom of the nitrogen-containing polymer or forms a salt crosslinking structure with the nitrogen atom of the nitrogen-containing polymer, and a contact angle with water, which is measured on a surface of the magnetic layer after hexane cleaning, (hereinafter, referred to as “contact angle after hexane cleaning”) is 90° or more.

In the present invention and the present specification, the term “portion on the non-magnetic support on the magnetic layer side” refers to a magnetic layer in a case of a magnetic recording medium including the magnetic layer directly on the non-magnetic support, and refers to a magnetic layer and/or a non-magnetic layer in a case of a magnetic recording medium including the non-magnetic layer between the non-magnetic support and the magnetic layer, which will be described below. The term “portion on the non-magnetic support on the magnetic layer side” is also simply described as a “portion on the magnetic layer side”. The presence of a certain component on the surface of the magnetic recording medium on the magnetic layer side is also included in the inclusion of the component in the portion on the magnetic layer side.

The magnetic recording medium includes the fluorine-based nitrogen-containing polymer in a portion on the magnetic layer side. The fluorine-based nitrogen-containing polymer contains a fluorine-containing group and a polyester chain.

It is considered that the fluorine-based nitrogen-containing polymer can function as a lubricant of the magnetic recording medium. The lubricant can be broadly divided into a boundary lubricant and a fluid lubricant. The present inventor considers that the fluorine-based nitrogen-containing polymer can function as a boundary lubricant by being present on a magnetic layer surface to impart lubricity to the magnetic layer surface. For example, it is considered that at least a part of the fluorine-based nitrogen-containing polymer included in the magnetic layer can be present on the magnetic layer surface. In addition, the present inventor supposes that the fluorine-based nitrogen-containing polymer included in the magnetic layer can be present on the magnetic layer surface by moving to the magnetic layer surface during sliding on the magnetic head. In addition, it is considered that the non-magnetic layer which will be described below may include the fluorine-based nitrogen-containing polymer, and the fluorine-based nitrogen-containing polymer included in the non-magnetic layer can move to the magnetic layer and further move to the magnetic layer surface to be present on the magnetic layer surface.

In addition, the present inventor considers that the contact angle after hexane cleaning can be an indicator of the content of the fluorine-based nitrogen-containing polymer in the portion on the magnetic layer side. In addition, the present inventor supposes that the inclusion of the fluorine-based nitrogen-containing polymer in the portion on the magnetic layer side in an amount such that the contact angle after hexane cleaning is 90° or more leads to the ability of the magnetic layer surface of the magnetic recording medium to exhibit smoothness so as to realize appropriate abrasiveness of the magnetic layer surface, a low friction coefficient after repeated running, and suppression of a change in surface shape of the magnetic layer before and after repeated running. The present inventor considers that the fluorine-containing group and the polyester chain contained in the fluorine-based nitrogen-containing polymer are hydrophobic parts, and that the provision of the hydrophobic parts contributes to imparting excellent lubricity to the magnetic layer surface.

Note that the above description is supposition and does not limit the present invention. In addition, the present invention is not limited to other supposition described in the present specification.

Hereinafter, the magnetic recording medium will be further described in detail.

### Contact Angle After Hexane Cleaning

In the present invention and the present specification, the contact angle with water, which is measured on the surface of the magnetic layer after hexane cleaning, (contact angle after hexane cleaning) is measured by the following method. In the present invention and the present specification, the “magnetic layer surface (surface of the magnetic layer)” has the same meaning as a surface of the magnetic recording medium on a magnetic layer side.

The term “room temperature” described in the present specification is a temperature in a range of 20° C. to 25° C. The following treatments are performed at room temperature unless otherwise noted.

### Hexane Cleaning

A sample piece for contact angle measurement is cut out from the magnetic recording medium to be measured. A size of the sample piece is set to 30 cm in length for the magnetic tape. A width of the magnetic tape is usually ½ inches. 1 inch is 0.0254 meters. For the magnetic tape having a width other than ½ inches, as a sample piece for contact angle measurement, a sample piece having a length of 30 cm is cut out. For a magnetic disk, a sample piece having the same size as that in the case of the magnetic tape need only be cut out.

The entire sample piece is immersed in 10 mL of fresh hexane for 1 hour. During the immersion, a container into which the sample and the hexane are put is allowed to stand without stirring or the like. As the hexane, n (normal)-hexane is used. The term “fresh” means unused.

After 1 hour, the sample piece is taken out from the hexane and naturally dried at room temperature for 24 hours or longer.

### Measurement of Contact Angle

The contact angle is obtained by a θ/2 method by dropwise adding water onto a measurement point on the magnetic layer surface of the sample piece after hexane cleaning in a measurement environment of an atmosphere temperature of 20° C. and a relative humidity of 25%. An example of measurement conditions will be described below in the section of Examples. The measurement point is set to six points randomly selected on the magnetic layer surface, and the contact angle is measured at each of the six points. An arithmetic average of the six measured values thus obtained is defined as the contact angle with water, which is measured on the surface of the magnetic layer of the magnetic recording medium to be measured after hexane cleaning.

From the viewpoint of realizing appropriate abrasiveness of the magnetic layer surface, a low friction coefficient after repeated running, and suppression of a change in surface shape of the magnetic layer before and after repeated running, the contact angle after hexane cleaning of the magnetic recording medium need only be 90° or more, and may be 95° or more or 100° or more. From the viewpoint of maintaining the strength of the magnetic layer, the contact angle after hexane cleaning of the magnetic recording medium is preferably 120° or less, more preferably 115° or less, and still more preferably 110° or less. A unit “° ” of the angle is also written as degree.

The contact angle after hexane cleaning of the magnetic recording medium can be controlled by the amount of the fluorine-based nitrogen-containing polymer used for manufacturing the magnetic recording medium. In addition, the contact angle after hexane cleaning of the magnetic recording medium can be controlled by the amount of a nitrogen-containing polymer and a fluorine-containing compound capable of forming the fluorine-based nitrogen-containing polymer in a manufacturing step of the magnetic recording medium as described below.

### Fluorine-Based Nitrogen-Containing Polymer

In the present invention and the present specification, the term “polymer” includes a homopolymer and a copolymer. The term “nitrogen-containing polymer” refers to a polymer having a nitrogen-containing repeating unit. The nitrogen-containing polymer may contain two or more kinds of nitrogen-containing repeating units having different structures.

In the fluorine-based nitrogen-containing polymer, the fluorine-containing group is bonded to a nitrogen atom of the fluorine-based nitrogen-containing polymer. In the fluorine-based nitrogen-containing polymer, the polyester chain is bonded to a nitrogen atom of the fluorine-based nitrogen-containing polymer or forms a salt crosslinking structure with a nitrogen atom of the fluorine-based nitrogen-containing polymer. The bond between the fluorine-containing group and the nitrogen atom and the bond between the polyester chain and the nitrogen atom can be a covalent bond. The fluorine-based nitrogen-containing polymer can include a plurality of fluorine-containing groups and a plurality of polyester chains. In the plurality of polyester chains, all of the plurality of polyester chains may be bonded to the nitrogen atoms of the fluorine-based nitrogen-containing polymer, all of the plurality of polyester chains may form a salt crosslinking structure with the nitrogen atoms of the fluorine-based nitrogen-containing polymer. A part of the plurality of polyester chains may be bonded to the nitrogen atoms of the fluorine-based nitrogen-containing polymer and the remaining part of the plurality of polyester chains may form a salt crosslinking structure with the nitrogen atoms of the fluorine-based nitrogen-containing polymer.

The fluorine-based nitrogen-containing polymer can be synthesized by a reaction between a nitrogen-containing polymer and a fluorine-containing compound. The reaction can easily proceed by mixing the nitrogen-containing polymer and the fluorine-containing compound at room temperature. In one aspect, it is possible to manufacture a magnetic recording medium including the fluorine-based nitrogen-containing polymer in the magnetic layer by forming the magnetic layer using the fluorine-based nitrogen-containing polymer synthesized by the reaction between the nitrogen-containing polymer and the fluorine-containing compound as a component of a composition for forming a magnetic layer. In another aspect, the nitrogen-containing polymer and the fluorine-containing compound are used as a component of the composition for forming a magnetic layer, and by mixing these components in a preparation step of the composition for forming a magnetic layer, the fluorine-based nitrogen-containing polymer can be formed by reacting the nitrogen-containing polymer with the fluorine-containing compound during the preparation step. The point described above is also applied to a case of forming the non-magnetic layer including the fluorine-based nitrogen-containing polymer. Hereinafter, the nitrogen-containing polymer capable of forming the fluorine-based nitrogen-containing polymer by reacting with the fluorine-containing compound is referred to as a “nitrogen-containing raw material polymer”.

The fluorine-based nitrogen-containing polymer can contain a plurality of polyester chains having the same or different structures. For the polyester chain contained in the fluorine-based nitrogen-containing polymer, the description regarding the polyester chain described below can be referred to.

The fluorine-based nitrogen-containing polymer can contain a plurality of fluorine-containing groups having the same or different structures. The fluorine-containing group of the fluorine-based nitrogen-containing polymer includes a group selected from the group consisting of a fluorinated alkyl group and a perfluoropolyether group. For the fluorinated alkyl group and the perfluoropolyether group, the description regarding the fluorine-containing compound described below can be referred to.

The fluorine-containing group can be a monovalent group represented by “*-L-Rf”. Here, “Rf” represents a fluorinated alkyl group or a perfluoropolyether group, and details thereof will be described below in relation to the fluorine-containing compound. * represents a bonding position where the above-described monovalent group is bonded to a nitrogen atom of the fluorine-based nitrogen-containing polymer. L represents a divalent linking group. Examples of the divalent linking group represented by L include “—(C═O)—” (carbonyl group) and “—(C═O)—NH—” (amide bond). For example, the above-described monovalent group can be a monovalent group represented by “*—(C—O)—Rf”, “*—(C═O)—NH—Rf”, or the like.

In one aspect, the fluorine-based nitrogen-containing polymer can be a polyalkyleneimine-based polymer. The “polyalkyleneimine-based polymer” is a polymer containing one or more polyalkyleneimine chains. The polyalkyleneimine chain is a polymerization structure including two or more identical or different alkyleneimine chains. The polyalkyleneimine chain will be described below. In one embodiment, it is considered that the polyalkyleneimine chain can function as an adsorption site to the ferromagnetic powder contained in the magnetic layer.

Hereinafter, the polyalkyleneimine-based polymer that can be used as the nitrogen-containing raw material polymer in a case where the fluorine-based nitrogen-containing polymer is a polyalkyleneimine-based polymer will be described. Unless otherwise noted, the following description regarding the polyalkyleneimine-based polymer also applies to a case where the above-described fluorine-based nitrogen-containing polymer is a polyalkyleneimine-based polymer.

### Nitrogen-Containing Raw Material Polymer

### Polyalkyleneimine Chain

In a case where the fluorine-based nitrogen-containing polymer is a polyalkyleneimine-based polymer, examples of the nitrogen-containing raw material polymer that can be used to obtain such a fluorine-based nitrogen-containing polymer include a polyalkyleneimine-based polymer having a polyester chain.

In a case where the nitrogen-containing raw material polymer is a polyalkyleneimine-based polymer, examples of the alkyleneimine chain contained in the polyalkyleneimine-based polymer include an alkyleneimine chain represented by Formula A and an alkyleneimine chain represented by Formula B. In the alkyleneimine chain represented by the following formula, the alkyleneimine chain represented by Formula A includes a bonding position with a polyester chain described below. In addition, the alkyleneimine chain represented by the formula B is bonded to a polyester chain by forming a salt crosslinking structure (details will be described below). In addition, the polyalkyleneimine chain may consist only of a linear structure or may have a branched tertiary amine structure. Examples of the chain having a branched structure include a chain that is bonded to an adjacent alkyleneimine chain in *¹ in Formula A and a chain that is bonded to an adjacent alkyleneimine chain in *² in Formula B.

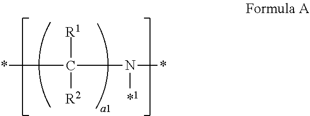

in Formula A, R¹ and R² each independently represent a hydrogen atom or an alkyl group, a1 represents an integer of 2 or more, and *¹ represents a bonding position with another adjacent polymer chain (for example, an adjacent alkyleneimine chain or a polyester chain described below) or a hydrogen atom or a substituent.

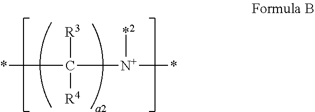

In Formula B, R³ and R⁴ each independently represent a hydrogen atom or an alkyl group, and a2 represents an integer of 2 or more. The alkyleneimine chain represented by Formula B can form a salt crosslinking structure with another polymer chain having an anionic group, and N′ in Formula B and an anionic group contained in the other polymer chain.

* in Formula A and Formula B and *² in Formula B each independently represent a position to be bonded to an adjacent alkyleneimine chain, a hydrogen atom, or a substituent.

Hereinafter, Formula A and Formula B will be described in more detail. In the present invention and the present specification, unless otherwise noted, groups described below may have a substituent or may be unsubstituted. In a case where a certain group has a substituent, examples of the substituent include an alkyl group (for example, an alkyl group having 1 to 6 carbon atoms), a hydroxy group, an alkoxy group (for example, an alkoxy group having 1 to 6 carbon atoms), a halogen atom (for example, a fluorine atom, a chlorine atom, or a bromine atom), a cyano group, an amino group, a nitro group, an acyl group, and a carboxyl group. IN addition, regarding a group having a substituent, the term “carbon atoms” means carbon atoms in a portion not including the substituent.

R¹ and R² in Formula A, and R³ and R⁴ in Formula B each independently represent a hydrogen atom or an alkyl group. Examples of the alkyl group include an alkyl group having 1 to 6 carbon atoms, preferably an alkyl group having 1 to 3 carbon atoms, more preferably a methyl group or an ethyl group, and still more preferably a methyl group. The combination of R¹ and R² in Formula A may be a form in which one is a hydrogen atom and the other is an alkyl group, a form in which both are hydrogen atoms, and a form in which both are alkyl groups (the same or different alkyl groups), and the form in which both are hydrogen atoms is preferable. The above point is also applied to R³ and R⁴ in Formula B.

As the alkyleneimine, a structure having the lowest number of carbon atoms constituting a ring is ethyleneimine, and the number of carbon atoms in a main chain of the alkyleneimine chain (ethyleneimine chain) obtained by the ring opening of the ethyleneimine is 2. Therefore, a lower limit of a1 in Formula A and a lower limit of a2 in Formula B are 2. That is, a1 in Formula A and a2 in Formula B each independently represent an integer of 2 or more. a1 in Formula A and a2 in Formula B may each be independently, for example, 10 or less, preferably 6 or less, more preferably 4 or less, still more preferably 2 or 3, and even still more preferably 2.

The details of the bonding of the alkyleneimine chain represented by Formula A and the alkyleneimine chain represented by Formula B to the polyester chain and the formation of the salt crosslinking structure will be described below.

Each of the above alkyleneimine chains is bonded to an adjacent alkyleneimine chain, a hydrogen atom, or substituent at a position represented by * in each formula. Examples of the substituent include a monovalent substituent such as an alkyl group (for example, an alkyl group having 1 to 6 carbon atoms), but the substituent is not limited thereto. In addition, as the substituent, another polymer chain (for example, a polyester chain described below) may be bonded.

A number-average molecular weight of the polyalkyleneimine chain contained in the polyalkyleneimine-based polymer is preferably 300 or more, and more preferably 500 or more. In addition, the number-average molecular weight of the polyalkyleneimine chain is preferably 3,000 or less, and more preferably 2,000 or less. The number-average molecular weight of the polyalkyleneimine chain contained in the polyalkyleneimine-based polymer is a value obtained as disclosed in a paragraph 0027 of JP2015-28830A. As disclosed in the same paragraph, a number-average molecular weight of the polyalkyleneimine used for synthesizing the polyalkyleneimine-based polymer can be employed as the number average molecular weight of the polyalkyleneimine chain contained in the polyalkyleneimine-based polymer.

In one aspect, a proportion of the polyalkyleneimine chain in the polyalkyleneimine-based polymer (hereinafter, also referred to as a “polyalkyleneimine chain ratio”) is preferably less than 5.0% by mass, more preferably 4.9% by mass or less, still more preferably 4.8% by mass or less, still more preferably 4.5% by mass or less, still more preferably 4.0% by mass or less, and even still more preferably 3.0% by mass or less. In addition, in one aspect, the polyalkyleneimine chain ratio is preferably 0.2% by mass or more, more preferably 0.3% by mass or more, and still more preferably 0.5% by mass or more.

The proportion of the polyalkyleneimine chain described above can be controlled, for example, by a mixing ratio of the polyalkyleneimine and the polyester used during synthesis.

The proportion of the polyalkyleneimine chain in the polyalkyleneimine-based polymer can be calculated from analysis results obtained by nuclear magnetic resonance (NMR), more specifically, by 1H-NMR and 13C-NMR, and elemental analysis using a well-known method. Since the value calculated in this way is the same as a theoretical value obtained from a blending ratio of raw materials for synthesizing the polyalkyleneimine-based polymer, the theoretical value obtained from the blending ratio can be employed as the proportion of the polyalkyleneimine chain in the polyalkyleneimine-based polymer (polyalkyleneimine chain ratio).

Regarding the fluorine-based nitrogen-containing polymer synthesized by using the polyalkyleneimine-based polymer as the nitrogen-containing raw material polymer, it can be said that the number-average molecular weight of the polyalkyleneimine chain and the proportion of the polyalkyleneimine chain in the polymer are the same as the number-average molecular weight of the polyalkyleneimine chain and the proportion of the polyalkyleneimine chain in the nitrogen-containing raw material polymer.

### Polyester Chain

The polyalkyleneimine-based polymer that can be used as the nitrogen-containing raw material polymer can contain a polyester chain together with the polyalkyleneimine chain described above. In the present invention and the present specification, the term “polyester chain” refers to a polymer chain having a plurality of ester bonds. In one aspect, the polyester chain is bonded to the alkyleneimine chain represented by Formula A via a nitrogen atom N and a carbonyl group —(C═O)— included in Formula A in *¹ of Formula A, to form —N—(C═O)—. In addition, in another aspect, the alkyleneimine chain represented by Formula B and the polyester chain can form a salt crosslinking structure by the nitrogen cation N′ in Formula B and the anionic group included in the polyester chain. Examples of the salt crosslinking structure include a structure formed of an oxygen anion O-contained in the polyester chain and N′ in Formula B, but the salt crosslinking structure is not limited thereto.

Examples of the polyester chain bonded to the alkyleneimine chain represented by Formula A via the nitrogen atom N and the carbonyl group —(C═O)— included in Formula A include a polyester chain represented by Formula 1. The polyester chain represented by Formula 1 can be bonded to the alkyleneimine chain represented by Formula A by forming —N—(C═O)— by the nitrogen atom contained in the alkyleneimine chain and the carbonyl group —(C═O)— contained in the polyester chain at the bonding position represented by *¹.

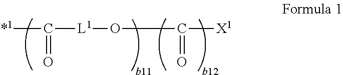

In addition, as the polyester chain bonded to the alkyleneimine chain represented by Formula B by forming the salt crosslinking structure by N⁺ in Formula B and the anionic group contained in the polyester chain, a polyester chain represented by Formula 2 can be used. The polyester chain represented by Formula 2 can form a salt crosslinking structure with N⁺ in Formula B by an oxygen anion O″.

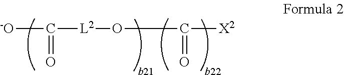

L¹ in Formula 1 and L² in Formula 2 each independently represent a divalent linking group. Preferred examples of the divalent linking group include an alkylene group having 3 to 30 carbon atoms. In a case where the alkylene group has a substituent, the number of carbon atoms in the alkylene group refers to the number of carbon atoms in a portion (main chain portion) excluding the substituent as described above.

b11 in Formula 1 and b21 in Formula 2 each independently represent an integer of 2 or more, and are, for example, an integer of 200 or less.

b12 in Formula 1 and b22 in Formula 2 each independently represent 0 or 1.

X¹ in Formula 1 and X² in Formula 2 each independently represent a hydrogen atom or a monovalent substituent. Examples of the monovalent substituent include a monovalent substituent selected from the group consisting of an alkyl group, a haloalkyl group (for example, a fluoroalkyl group), an alkoxy group, a polyalkyleneoxyalkyl group, and an aryl group.

The alkyl group may have a substituent or may be unsubstituted. As the alkyl group having a substituent, an alkyl group substituted with a hydroxy group (hydroxyalkyl group) or an alkyl group substituted with one or more halogen atoms is preferable. In addition, an alkyl group (haloalkyl group) in which all hydrogen atoms bonded to carbon atoms are substituted with halogen atoms is also preferable. Examples of the halogen atom include a fluorine atom, a chlorine atom, and a bromine atom. The alkyl group is more preferably an alkyl group having 1 to 30 carbon atoms and still more preferably an alkyl group having 1 to 10 carbon atoms. The alkyl group may be any of linear, branched, or cyclic. The same applies to the haloalkyl group.

For specific examples of the substituted or unsubstituted alkyl group and the haloalkyl group, a description disclosed in a paragraph 0052 of JP2015-28830A can be referred to. For specific examples of the alkoxy group, a description disclosed in a paragraph 0053 of JP2015-28830A can be referred to.

The polyalkyleneoxyalkyl group is a monovalent substituent represented by R¹⁰ (OR¹¹)n(O)m-. R¹⁰ represents an alkyl group, R¹¹ represents an alkylene group, n represents an integer of 2 or more, and m represents 0 or 1.

The alkyl group represented by R¹⁰ is as described with respect to the alkyl groups represented by X¹ and X². Regarding the details of the alkylene group represented by R¹¹, the above description regarding the alkyl groups represented by X¹ and X² can be applied by replacing the alkyl group with an alkylene group in which one hydrogen atom is removed from the alkylene group (for example, a methyl group is replaced with the methylene group). n is an integer of 2 or more, and is, for example, an integer of 10 or less and preferably an integer of 5 or less.

The aryl group may have a substituent or may be fused, and is more preferably an aryl group having 6 to 24 carbon atoms, and examples thereof include a phenyl group, a 4-methylphenyl group, 4-phenylbenzoic acid, a 3-cyanophenyl group, a 2-chlorophenyl group, and a 2-naphthyl group.

Each of the polyester chain represented by Formula 1 and the polyester chain represented by Formula 2 can have a structure derived from polyester obtained by a well-known polyester synthesis method. Examples of the polyester synthesis method include ring-opening polymerization of a lactone. Examples of the lactone include various lactones disclosed in a paragraph 0056 of JP2015-28830A. As the lactone, from the viewpoint of reactivity and/or availability, &-caprolactone, lactide, or 8-valerolactone is preferable. Note that the present invention is not limited thereto, and any lactone may be used as long as polyester can be obtained by ring-opening polymerization.

For a nucleophilic reagent for ring-opening polymerization of a lactone, a description disclosed in a paragraph 0057 of JP2015-28830A can be referred to.

Note that the polyester chain is not limited to the structure derived from polyester obtained by ring-opening polymerization of a lactone, and it can also have a structure derived from polyester obtained by a well-known polyester synthesis method such as polycondensation of a polyvalent carboxylic acid and a polyhydric alcohol, or polycondensation of hydroxycarboxylic acid.

In one aspect, a number-average molecular weight of the polyester chain is preferably 200 or more, more preferably 400 or more, and still more preferably 500 or more. In addition, in one aspect, the number-average molecular weight of the polyester chain is preferably 100,000 or less and more preferably 50,000 or less. The number-average molecular weight of the polyester chain is a value obtained as disclosed in a paragraph 0059 of JP2015-28830A. Weight-Average Molecular Weight of Polyalkyleneimine-Based Polymer

An average molecular weight of the polyalkyleneimine-based polymer that can be used as the nitrogen-containing raw material polymer may be, for example, 1,000 or more and may be, for example, 80,000 or less as the weight-average molecular weight. In addition, a weight-average molecular weight of the polyalkyleneimine-based polymer that can be used as the nitrogen-containing raw material polymer is preferably 1,500 or more, more preferably 2,000 or more, and still more preferably 3,000 or more. In addition, in one aspect, the weight-average molecular weight of the polyalkyleneimine-based polymer that can be used as the nitrogen-containing raw material polymer is preferably 60,000 or less, more preferably 40,000 or less, still more preferably 35,000 or less, still preferably 34,000 or less, still more preferably 30,000 or less, still more preferably 20,000 or less, and even still more preferably 10,000 or less.

The above description can be applied to the weight-average molecular weight in a case where the fluorine-based nitrogen-containing polymer is a polyalkyleneimine-based polymer.

In the present invention and the present specification, the weight-average molecular weight of the polyalkyleneimine-based polymer refers to a value obtained by standard polystyrene conversion using gel permeation chromatography (GPC). For measurement conditions, a description disclosed in the section of Examples of JP2015-28830A can be referred to.

### Synthesis Method

A synthesis method of the polyalkyleneimine-based polymer is not particularly limited. For one aspect of the synthesis method, paragraphs 0061 to 0069 and Examples of JP2015-28830A can be referred to.

### Fluorine-Containing Compound

Examples of the fluorine-containing compound capable of forming the fluorine-based nitrogen-containing polymer include a compound having one or more groups selected from the group consisting of a fluorinated alkyl group and a perfluoropolyether group in one molecule.

The fluorinated alkyl group has a structure in which a part or all of hydrogen atoms constituting an alkyl group are substituted with fluorine atoms, and preferably has a structure in which all of hydrogen atoms constituting an alkyl group are substituted with fluorine atoms. That is, the fluorinated alkyl group is preferably a perfluoroalkyl group. The fluorinated alkyl group may have a linear structure or a branched structure, may be a cyclic fluorinated alkyl group, and preferably has a linear structure. The fluorinated alkyl group may have a substituent, may be unsubstituted, and is preferably unsubstituted. The fluorinated alkyl group may have a structure in which some or all of the hydrogen atoms constituting the alkyl group represented by, for example, CₙH₂ₙ₊₁₋ are substituted with fluorine atoms. The fluorinated alkyl group may have, for example, 1 or more, 2 or more, or 3 or more carbon atoms. In addition, the fluorinated alkyl group may have, for example, 20 or less, 15 or less, 10 or less, 7 or less, 6 or less, 5 or less, or 4 or less carbon atoms.

The perfluoropolyether group refers to a perfluoroalkyl group having one or more ether bonds, and may be a monovalent group or a divalent or higher group. Examples of the perfluoropolyether group include a monovalent group such as CF₃—(CF₂O)ₚ—(CF₂CF₂₀)_{q}—, CF₃—[CF(CF₃)CF₂₀]ₚ—[CF₂ (CF₃)]—, CF₃—(CF₂CF₂CF₂₀)ₚ—, CF₃—(CF₂CF₂O)ₚ—, and CF₃—(CF₂)ₚ—O—[CF(CF₃)CF₂OCF(CF₃)]_{q}—. The total of p and q is preferably 1 to 83, more preferably 1 to 43, and still more preferably 5 to 23.

In one aspect, examples of the fluorine-containing compound include a fluorinated alkyl group-containing carboxylic acid ester or a perfluoropolyether group-containing carboxylic acid ester represented by “RfCOOX”. Here, “Rf” represents a fluorinated alkyl group or a perfluoropolyether group, and the details thereof are as described above. “X” represents an alkyl group. Examples of the alkyl group include an alkyl group having 1 to 6 carbon atoms, preferably an alkyl group having 1 to 3 carbon atoms, more preferably a methyl group or an ethyl group, and still more preferably a methyl group. Specific examples of the carboxylic acid ester represented by “RfCOOX” include the following fluorine-containing compounds.

C₁₁F₂₃COOCH₃

C₉F₁₉COOCH₃

C₆F₁₃COOCH₃

C₅F₁₁COOCH₃

C₄FOCOOCH₃

C₃F₇COOCH₃

(CF₃)₂CFCOOCH₃

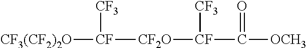

In another aspect, examples of the fluorine-containing compound include a fluorinated alkyl group-containing isocyanate or a perfluoropolyether group-containing isocyanate represented by “RfNCO”. Here, “Rf” represents a fluorinated alkyl group or a perfluoropolyether group, and the details thereof are as described above. Specific examples of the isocyanate represented by “RfNCO” include C₄F₉NCO (nonafluorobutyl isocyanate).

The fluorine-containing compound may be obtained as a commercially available product or may be synthesized by a well-known method.

For example, the magnetic layer or the composition for forming a magnetic layer can contain the above-described fluorine-based nitrogen-containing polymer in an amount of 0.1 parts by mass or more and preferably in an amount of 0.5 parts by mass or more with respect to 100 parts by mass of the ferromagnetic powder. In addition, a content of the fluorine-based nitrogen-containing polymer in the magnetic layer or the composition for forming a magnetic layer may be, for example, 20.0 parts by mass or less, 15.0 parts by mass or less, or 10.0 parts by mass or less per 100 parts by mass of the ferromagnetic powder. The fluorine-based nitrogen-containing polymer contained in the magnetic layer or the composition for forming a magnetic layer may be used alone or in combination of two or more kinds thereof. In a case where two or more kinds thereof are contained, the above content is the total content of the two or more kinds of fluorine-based nitrogen-containing polymers.

In addition, in a case where the nitrogen-containing raw material polymer and the fluorine-containing compound are used as a component of the composition for forming a magnetic layer, the contents of the nitrogen-containing raw material polymer and the fluorine-containing compound in the composition for forming a magnetic layer are as follows.

A content of the nitrogen-containing raw material polymer in the composition for forming a magnetic layer is preferably 0.1 parts by mass or more and more preferably 0.5 parts by mass or more per 100 parts by mass of the ferromagnetic powder. The content of the nitrogen-containing raw material polymer in the composition for forming a magnetic layer may be, for example, 20.0 parts by mass or less, 15.0 parts by mass or less, or 10.0 parts by mass or less per 100 parts by mass of the ferromagnetic powder.

A content of the fluorine-containing compound in the composition for forming a magnetic layer is preferably 1.0 part by mass or more, more preferably 3.0 parts by mass or more, and still more preferably 5.0 parts by mass or more per 100 parts by mass of the ferromagnetic powder. The content of the fluorine-containing compound in the composition for forming a magnetic layer may be, for example, 20.0 parts by mass or less, 15.0 parts by mass or less, or 10.0 parts by mass or less per 100 parts by mass of the ferromagnetic powder.

Regarding the non-magnetic layer and a composition for forming a non-magnetic layer, the above description can be applied by replacing the ferromagnetic powder with the non-magnetic powder.

Regarding a mixing ratio of the nitrogen-containing raw material polymer and the fluorine-containing compound, with the total amount of a fluorine-containing raw material polymer and the fluorine-containing compound (on a mass basis) being 100% by mass, the ratio of the fluorine-containing compound may be 10% by mass or more, 15% by mass or more, 20% by mass or more, 25% by mass or more, or 30% by mass or more, and may be 90% by mass or less, 80% by mass or less, 70% by mass or less, 60% by mass or less, or 50% by mass or less.

The magnetic recording medium may or may not include, together with the fluorine-based nitrogen-containing polymer, a nitrogen-containing polymer other than the fluorine-based nitrogen-containing polymer (hereinafter, also referred to as “other nitrogen-containing polymer”) in the portion on the non-magnetic support on the magnetic layer side. In one aspect, as the other nitrogen-containing polymer, the polyalkyleneimine-based polymer described above as an example of the nitrogen-containing raw material polymer can be used. The polyalkyleneimine-based polymer described above can function as a dispersing agent for improving dispersibility of the ferromagnetic powder. The fluorine-based nitrogen-containing polymer can also function as a dispersing agent for improving dispersibility of the ferromagnetic powder.

In a case of including the other nitrogen-containing polymer, a content of the other nitrogen-containing polymer in the magnetic layer or the composition for forming a magnetic layer may be, for example, 0.1 parts by mass or more and 20.0 parts by mass or less, or 1.0 part by mass or more and 15.0 parts by mass or less per 100 parts by mass of the ferromagnetic powder. Regarding the non-magnetic layer and the composition for forming a non-magnetic layer, the above description can be applied by replacing the ferromagnetic powder with the non-magnetic powder.

Hereinafter, the magnetic layer of the magnetic recording medium and the like will be further described in detail.

### Magnetic Layer

### Ferromagnetic Powder

A magnetic layer contains a ferromagnetic powder. As a ferromagnetic powder included in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

### Hexagonal Ferrite Powder

Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite crystal structure in an X-ray diffraction spectrum obtained by X-ray diffraction analysis, it is determined that the hexagonal ferrite crystal structure is detected as the main phase. In a case where only a single structure is detected by X-ray diffraction analysis, this detected structure is taken as the main phase. The hexagonal ferrite crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Note that a rare earth atom is not included in the above divalent metal atom. The term “rare earth atom” in the present invention and the present specification is selected from the group consisting of a scandium atom (Sc), an yttrium atom (Y), and a lanthanoid atom. The lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is one aspect of the hexagonal ferrite powder, will be described in more detail.

An activation volume of the hexagonal strontium ferrite powder is preferably in a range of 800 to 1500 nm³. The finely granulated hexagonal strontium ferrite powder having an activation volume in the above range is suitable for manufacturing a magnetic recording medium exhibiting excellent electromagnetic conversion characteristics. The activation volume of the hexagonal strontium ferrite powder is preferably 800 nm³ or more, and may be, for example, 850 nm³ or more. From the viewpoint of further improving the electromagnetic conversion characteristics, the activation volume of the hexagonal strontium ferrite powder is more preferably 1400 nm³ or less, still more preferably 1300 nm³ or less, still more preferably 1200 nm³ or less, and still more preferably 1100 nm³ or less.

The term “activation volume” refers to a unit of magnetization reversal and is an index indicating the magnetic size of a particle. An activation volume described in the present invention and the present specification and an anisotropy constant Ku which will be described below are values obtained from the following relational expression between a coercivity Hc and an activation volume V, by performing measurement in a coercivity Hc measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

$$Hc = 2 Ku / Ms \{ 1 - {[ ( kT / KuV ) ln ( At / 0.693 ) ]}^{1 / 2} \}$$

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s-1), t: magnetic field reversal time (unit: s)]

An index for reducing thermal fluctuation, in other words, for improving the thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10⁵ J/m³ or less. Here, since higher Ku means higher thermal stability, which is preferable, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In one aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom.) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom.) satisfy a ratio of a rare earth atom surface layer portion content/a rare earth atom bulk content >1.0. A rare earth atom content in the hexagonal strontium ferrite powder described below is synonymous with the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes the rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

It is speculated that the use of the hexagonal strontium ferrite powder having the rare earth atom surface layer portion uneven distribution property as the ferromagnetic powder of the magnetic layer contributes to the prevention of scraping of the magnetic layer surface due to the sliding on the magnetic head. That is, it is speculated that the hexagonal strontium ferrite powder having the rare earth atom surface layer portion uneven distribution property can also contribute to the improvement of running durability of the magnetic recording medium. It is speculated that this may be because uneven distribution of rare earth atoms on a surface of a particle constituting the hexagonal strontium ferrite powder contributes to an improvement of interaction between the particle surface and an organic substance (for example, a binding agent and/or an additive) contained in the magnetic layer, and, as a result, a strength of the magnetic layer is improved.

From the viewpoint of further suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in a case of including two or more kinds of rare earth atoms is obtained for the total of two or more kinds of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of further suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for the hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Note that, in the hexagonal strontium ferrite powder having a rare earth atom surface layer portion uneven distribution property, the rare earth atoms need only be unevenly distributed in the surface layer portion of a particle constituting the hexagonal strontium ferrite powder, and the “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic recording medium, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Note that the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution thus obtained is performed by an inductively coupled plasma (ICP) analyzer. In this way, the surface layer portion content of a rare earth atom with respect to 100 at % of an iron atom can be obtained. In a case where a plurality of kinds of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic recording medium, it is desirable that mass magnetization σs of the ferromagnetic powder included in the magnetic recording medium is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In one aspect, σs of the hexagonal strontium ferrite powder may be 45 A·m²/kg or more, and may be 47 A·m²/kg or more. On the other hand, from the viewpoint of noise reduction, σs is preferably 80 A m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 1194 kA/m (15 kOe).

Regarding the content (bulk content) of a constituent atom of the hexagonal strontium ferrite powder, a strontium atom content may be, for example, in a range of 2.0 to 15.0 at % with respect to 100 at % of an iron atom. In one aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where the other divalent metal atoms other than the strontium atom are included, a content of the barium atom and a content of the calcium atom in the hexagonal strontium ferrite powder respectively can be, for example, in a range of 0.05 to 5.0 at % with respect to 100 at % of the iron atom.

As the hexagonal ferrite crystal structure, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to one aspect, in the hexagonal strontium ferrite powder, only the M-type crystal structure may be detected by X-ray diffraction analysis. For example, M type hexagonal ferrite is represented by a composition formula of AFe12019. Here, A represents a divalent metal atom, and in a case where the hexagonal strontium ferrite powder is the M type, A is only a strontium atom (Sr), or in a case where, as A, a plurality of divalent metal atoms are included, as described above, a strontium atom (Sr) accounts for the most on an at % basis. The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of further suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in one aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In one aspect, the hexagonal strontium ferrite powder may not include a bismuth atom (Bi).

### Metal Powder

Preferred specific examples of the ferromagnetic powder include a ferromagnetic metal powder. For details of the ferromagnetic metal powder, descriptions disclosed in paragraphs 0137 to 0141 of JP2011-216149A and paragraphs 0009 to 0023 of JP2005-251351A can be referred to, for example.

### ε-Iron Oxide Powder

Preferred specific examples of the ferromagnetic powder include an ε-iron oxide powder. In the present invention and the present specification, the term “ε-iron oxide powder” refers to a ferromagnetic powder in which an s-iron oxide crystal structure is detected as a main phase by X-ray diffraction analysis. For example, in a case where the highest intensity diffraction peak is attributed to an s-iron oxide crystal structure in an X-ray diffraction spectrum obtained by X-ray diffraction analysis, it is determined that the ε-iron oxide crystal structure is detected as the main phase. As a method of manufacturing an ε-iron oxide powder, a manufacturing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Note that the method of manufacturing the s-iron oxide powder capable of being used as the ferromagnetic powder in the magnetic layer of the magnetic recording medium is not limited to the methods described here.

An activation volume of the s-iron oxide powder is preferably in a range of 300 to 1500 nm³. The finely granulated s-iron oxide powder having an activation volume in the above range is suitable for manufacturing a magnetic recording medium exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the s-iron oxide powder is more preferably 1400 nm³ or less, still more preferably 1300 nm³ or less, still more preferably 1200 nm³ or less, and still more preferably 1100 nm³ or less

An index for reducing thermal fluctuation, in other words, for improving the thermal stability may include the anisotropy constant Ku. The s-iron oxide powder preferably has Ku of 3.0×10⁴ J/m³ or more, and more preferably has Ku of 8.0×10⁴ J/m³ or more. Ku of the ε-iron oxide powder may be, for example, 3.0×10⁵ J/m³ or less. Here, since higher Ku means higher thermal stability, which is preferable, a value thereof is not limited to the values exemplified above.

From the viewpoint of increasing the reproduction output in a case of reproducing data recorded on the magnetic recording medium, it is desirable that mass magnetization σs of the ferromagnetic powder included in the magnetic recording medium is high. In this regard, in one aspect, σs of the ε-iron oxide powder may be 8 A·m²/kg or more, and may be 12 A·m²/kg or more. On the other hand, from the viewpoint of noise reduction, σs of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000× with a transmission electron microscope, the image is printed on photographic printing paper or displayed on a display so that the total magnification of 500000× to obtain an image of particles configuring the powder. A target particle is selected from the obtained image of particles, an outline of the particle is traced by a digitizer, and a size of the particle (primary particle) is measured. The primary particles are independent particles without aggregation.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic recording medium in order to measure the particle size, a method disclosed in a paragraph 0015 of JP2011-048878A can be employed, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter refers to a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %, with respect to the total mass of the magnetic layer. The magnetic layer includes the ferromagnetic powder, can include the binding agent, and can also include any one or more kinds of additives. A high filling percentage of the ferromagnetic powder in the magnetic layer is preferable from the viewpoint of improving the recording density.

### Binding Agent and Curing Agent

The magnetic recording medium can be a coating type magnetic recording medium, and can include a binding agent in the magnetic layer. The binding agent is one or more kinds of resin. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A can also be referred to. The content of the binding agent of the magnetic layer can be, for example, 1.0 to 30.0 parts by mass with respect to 100.0 parts by mass of the ferromagnetic powder. An average molecular weight of the resin used as the binding agent can be, for example, 10,000 or more and 200,000 or less as a weight-average molecular weight. Unless otherwise noted, the weight-average molecular weight in the present invention and the present specification is a value obtained by performing standard polystyrene conversion of a value measured by gel permeation chromatography (GPC) under the following measurement conditions. The binding agent may be used in an amount of, for example, 1.0 to 30.0 parts by mass with respect to 100.0 parts by mass of the ferromagnetic powder.

GPC device: HLC-8120 (manufactured by Tosoh Corporation)

Column: TSK gel Multipore HXL-M (manufactured by Tosoh Corporation, 7.8 mm inner diameter (ID)×30.0 cm)

Eluent: tetrahydrofuran (THF)

A curing agent can also be used together with the resin which can be used as the binding agent. As the curing agent, in one aspect, a thermosetting compound which is a compound in which curing reaction (crosslinking reaction) proceeds due to heating can be used, and in another aspect, a photocurable compound in which a curing reaction (crosslinking reaction) proceeds due to light irradiation can be used. The curing reaction proceeds in a magnetic layer forming step, whereby at least a part of the curing agent can be included in the magnetic layer in a state of being reacted (crosslinked) with other components such as the binding agent. The same applies to the layer formed using this composition in a case where the composition used to form the other layer includes a curing agent. The preferred curing agent is a thermosetting compound, and polyisocyanate is suitable for this. For details of the polyisocyanate, descriptions disclosed in paragraphs 0124 and 0125 of JP2011-216149A can be referred to. The content of the curing agent in the composition for forming a magnetic layer may be, for example, 0 to 80.0 parts by mass, and from the viewpoint of improving a strength of the magnetic layer, may be 50.0 to 80.0 parts by mass, with respect to 100.0 parts by mass of the binding agent.

### Additive

The magnetic layer may include one or more kinds of additives, as necessary. As the additives, the curing agent described above is used as an example. In addition, examples of the additive which can be included in the magnetic layer include a non-magnetic powder, a lubricant, a dispersing agent, a dispersing assistant, a fungicide, an antistatic agent, and an antioxidant. For the dispersing agent, descriptions disclosed in paragraphs 0061 and 0071 of JP2012-133837A can be referred to. The dispersing agent may be added to a composition for forming a non-magnetic layer. For the dispersing agent that can be added to the composition for forming a non-magnetic layer, a description disclosed in a paragraph 0061 of JP2012-133837A can be referred to. In addition, examples of the non-magnetic powder that can be included in the magnetic layer include a non-magnetic powder which can function as an abrasive and a non-magnetic powder which can function as a protrusion forming agent which forms protrusions suitably protruded from the magnetic layer surface. Examples of the abrasive include powders of alumina (Al₂O₃), silicon carbide, boron carbide (B₄C), TiC chromium oxide (Cr₂O₃), cerium oxide, zirconium oxide (ZrO₂), iron oxide, and diamond that are materials normally used as the abrasive of the magnetic layer. The powders of alumina such as a-alumina, silicon carbide, and diamond are preferable among the above. A content of the abrasive in the magnetic layer is preferably 1.0 to 20.0 parts by mass, more preferably 3.0 to 15.0 parts by mass, and even more preferably 4.0 to 10.0 parts by mass, with respect to 100.0 parts by mass of the ferromagnetic powder. An average particle size of the abrasive is, for example, in a range of 30 to 300 nm, and preferably in a range of 50 to 200 nm. As the protrusion forming agent, carbon black, colloidal particles, and the like can be used. A content of the protrusion forming agent in the magnetic layer is preferably 0.1 to 10.0 parts by mass, more preferably 0.1 to 5.0 parts by mass, and still more preferably 0.5 to 5.0 parts by mass with respect to 100.0 parts by mass of the ferromagnetic powder. An average particle size of the colloidal particles is, for example, preferably in a range of 90 to 200 nm, and more preferably in a range of 100 to 150 nm. An average particle size of the carbon black is preferably in a range of 5 to 200 nm and more preferably in a range of 10 to 150 nm.

The magnetic recording medium can contain one or more fatty acid compounds selected from the group consisting of a fatty acid, a fatty acid ester, and a fatty acid amide in a portion on the non-magnetic support on the magnetic layer side. The above-described fatty acid compound can function as a lubricant. The portion on the magnetic layer side may contain only one fatty acid compound selected from a fatty acid, a fatty acid ester, and a fatty acid amide, or may contain two or three components. In addition, only one or two or more fatty acids may be contained as the fatty acid. The same applies to the fatty acid ester and the fatty acid amide.

Examples of the fatty acid include lauric acid, myristic acid, palmitic acid, stearic acid, oleic acid, linoleic acid, linolenic acid, behenic acid, erucic acid, elaidic acid, stearic acid, myristic acid, and palmitic acid are preferable, and stearic acid is more preferable. The fatty acid may be included in the magnetic layer in a form of a salt such as a metal salt.

Examples of the fatty acid ester include esters of the above-described exemplified various fatty acids. Specific examples thereof include butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate.

Examples of the fatty acid amide include amides of the above-described exemplified various fatty acids. Specific examples thereof include amides of the various fatty acids, for example, lauric acid amide, myristic acid amide, palmitic acid amide, and stearic acid amide.

For the fatty acid and a derivative of the fatty acid (such as amide and ester), a fatty acid-derived moiety of the fatty acid derivative preferably has a structure which is the same as or similar to that of the fatty acid used in combination. For example, in a case where stearic acid is used as the fatty acid, it is preferable to use stearic acid amide and/or stearic acid ester in combination.

In one aspect, the magnetic recording medium containing one or more fatty acid compounds selected from the group consisting of a fatty acid, a fatty acid ester, and a fatty acid amide in the portion on the magnetic layer side can be manufactured by forming the magnetic layer using the composition for forming a magnetic layer containing one or more of the above fatty acid compounds. In addition, in one aspect, the magnetic recording medium containing one or more of the fatty acid compounds in the portion on the magnetic layer side can be manufactured by forming the non-magnetic layer using the composition for forming a non-magnetic layer containing one or more of the above fatty acid compounds. In addition, in one aspect, the magnetic recording medium containing one or more of the fatty acid compounds in the portion on the magnetic layer side can be manufactured by forming the non-magnetic layer using the composition for forming a non-magnetic layer containing one or more of the above fatty acid compounds and the magnetic layer using the composition for forming a magnetic layer containing one or more of the above fatty acid compounds. The non-magnetic layer can play a role of holding a component that can function as a lubricant such as a fatty acid, a fatty acid ester, a fatty acid amide, and a fatty acid amide, and supplying the component to the magnetic layer. The lubricant such as a fatty acid, a fatty acid ester, and a fatty acid amide included in the non-magnetic layer may be transferred to the magnetic layer and present in the magnetic layer.

A content of the fatty acid in the magnetic layer or the composition for forming a magnetic layer is preferably 0.5 to 3.0 parts by mass with respect to 100.0 parts by mass of the ferromagnetic powder.

A content of the fatty acid ester in the magnetic layer or the composition for forming a magnetic layer is, for example, 0 to 10.0 parts by mass, and preferably 0.5 to 7.0 parts by mass per 100.0 parts by mass of the ferromagnetic powder.

A content of the fatty acid amide in the magnetic layer or the composition for forming a magnetic layer is, for example, 0 to 1.0 part by mass, and preferably 0.1 to 1.0 part by mass per 100.0 parts by mass of the ferromagnetic powder.

Regarding contents of the fatty acid, the fatty acid ester, and the fatty acid amide in the non-magnetic layer or the composition for forming a non-magnetic layer, the above description can be applied by replacing the ferromagnetic powder with the non-magnetic powder.

Regarding a mixing ratio of the fluorine-based nitrogen-containing polymer and the fatty acid compound in the magnetic layer or the composition for forming a magnetic layer, with the total amount of the fluorine-containing raw material polymer and the fatty acid compound (on a mass basis) being 100% by mass, the ratio of the fatty acid compound can be 10% by mass or more, 15% by mass or more, 20% by mass or more, 25% by mass or more, or 30% by mass or more, and can be 90% by mass or less, 80% by mass or less, 70% by mass or less, 60% by mass or less, or 50% by mass or less. The above-described point also applies to a mixing ratio of the fluorine-based nitrogen-containing polymer and the fatty acid compound in the non-magnetic layer or the composition for forming a non-magnetic layer.

The magnetic layer described above can be provided on a surface of the non-magnetic support directly or indirectly through the non-magnetic layer.

### Non-Magnetic Layer

Next, the non-magnetic layer will be described. The above magnetic recording medium may have a magnetic layer directly on the surface of the non-magnetic support, or may have a magnetic layer on the surface of the non-magnetic support via a non-magnetic layer including non-magnetic powder. The non-magnetic powder used in the non-magnetic layer may be an inorganic powder or an organic powder. In addition, the carbon black and the like can be used. Examples of the inorganic powder include powders of metal, metal oxide, metal carbonate, metal sulfate, metal nitride, metal carbide, and metal sulfide. The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 mass % and more preferably in a range of 60 to 90 mass %.

The non-magnetic layer can be a layer containing the non-magnetic powder and the binding agent and can further contain one or more kinds of additives. For other details of the binding agent or the additive of the non-magnetic layer, a well-known technology regarding the non-magnetic layer can be applied. In addition, in regards to the type and the content of the binding agent, and the type and the content of the additive, for example, the well-known technology regarding the magnetic layer can be applied.

The non-magnetic layer of the present invention and the present specification also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having a coercivity equal to or smaller than 100 Oe, or a layer having a residual magnetic flux density equal to or smaller than 10 mT and a coercivity equal to or smaller than 100 Oe. 1 [kOe] is 10⁶/4π [A/m]. It is preferable that the non-magnetic layer does not have a residual magnetic flux density and coercivity.

### Non-Magnetic Support

Next, the non-magnetic support (hereinafter, referred to as a “support”) will be described. As the non-magnetic support, well-known components such as polyethylene terephthalate, polyethylene naphthalate, polyamide, polyamide imide, and aromatic polyamide subjected to biaxial stretching are used. Among these, polyethylene terephthalate, polyethylene naphthalate, and polyamide are preferable. A corona discharge, a plasma treatment, an easy-bonding treatment, or a heat treatment may be performed on these supports in advance.

### Back Coating Layer

The magnetic recording medium can also include a back coating layer containing a non-magnetic powder on a surface side of the non-magnetic support opposite to the surface side on which the magnetic layer is provided. The back coating layer preferably contains any one or both of carbon black and an inorganic powder. The back coating layer can be a layer containing the non-magnetic powder and the binding agent and can further contain one or more kinds of additives. In regards to the binding agent of the back coating layer and various additives that may be randomly included therein, a well-known technology regarding the back coating layer can be applied, and a well-known technology regarding formulation of the magnetic layer and/or the non-magnetic layer can also be applied. For example, for the back coating layer, descriptions disclosed in paragraphs 0018 to 0020 of JP2006-331625A and page 4, line 65, to page 5, line 38, of U.S. Pat. No. 7,029,774B can be referred to. Various Thicknesses

A thickness of the non-magnetic support is, for example, 3.0 to 80.0 μm, preferably 3.0 to 20.0 μm, more preferably 3.0 to 10.0 μm, and still more preferably 3.0 to 6.0 μm.

A thickness of the magnetic layer can be optimized according to saturation magnetization amount of the magnetic head used, a head gap length, a recording signal band, and the like. The thickness of the magnetic layer is preferably 10 nm to 150 nm, and is more preferably 20 nm to 120 nm, and even more preferably 30 nm to 100 nm from a viewpoint of realization of high-density recording. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 3.0 μm, preferably 0.1 to 2.0 μm, and more preferably 0.1 to 1.5 μm.

A thickness of the back coating layer is preferably 0.9 μm or less and more preferably in a range of 0.1 to 0.7 μm.

Thicknesses of each layer and the non-magnetic support of the magnetic recording medium can be obtained by a well-known film thickness measurement method. As an example, a cross section of the magnetic recording medium in a thickness direction is exposed by well-known means such as an ion beam or a microtome, and then the exposed cross section observation is performed using a scanning electron microscope, for example. In the cross section observation, various thicknesses can be obtained as a thickness obtained at any one portion of the cross section, or an arithmetic average of thicknesses obtained at a plurality of portions of two or more portions, for example, two portions which are randomly extracted. Alternatively, the thickness of each layer may be obtained as a designed thickness calculated under the manufacturing conditions.

### Manufacturing Method of Magnetic Recording Medium

A step of preparing a composition for forming the magnetic layer, as well as the optional non-magnetic layer and back coating layer, can usually include at least a kneading step, a dispersing step, and, as necessary, a mixing step provided before and after these steps. Each step may be divided into two or more stages. Components used in the preparation of the composition for forming each layer may be added at the beginning or during any step. In addition, each raw material may be separately added in two or more steps. As described above, one or more kinds of nitrogen-containing raw material polymers and one or more kinds of the fluorine-containing compounds are used as components of the composition for forming a magnetic layer, and these are mixed in a step of preparing the composition for forming a magnetic layer to form the fluorine-based nitrogen-containing polymer. In addition, in one aspect, the composition for forming a magnetic layer can be prepared by mixing one or more kinds of nitrogen-containing raw material polymers and one or more kinds of the fluorine-containing compounds to form the fluorine-based nitrogen-containing polymer before preparation of the composition for forming a magnetic layer, and then using the polymer as a component of the composition for forming a magnetic layer. This point also applies to a step of preparing the composition for forming a non-magnetic layer. In order to prepare a composition for forming each layer, a well-known technology can be used. In the kneading step, an open kneader, a continuous kneader, a pressure kneader, or a kneader having a strong kneading force such as an extruder is preferably used. Details of the kneading treatment are described in JP1989-106338A (JP-H01-106338A) and JP1989-79274A (JP-H01-79274A). In addition, in order to disperse the composition for forming each layer, one or more kinds of dispersion beads selected from the group consisting of glass beads and other dispersion beads can be used as a dispersion medium. As such dispersion beads, zirconia beads, titania beads, and steel beads which are dispersion beads having a high specific gravity are suitable. These dispersion beads may be used by optimizing a particle diameter (bead diameter) and a filling percentage of the dispersion beads. As a dispersing device, a well-known dispersing device can be used. The composition for forming each layer may be filtered by a well-known method before performing the coating step. The filtering can be performed by using a filter, for example. As the filter used in the filtering, a filter having a pore diameter of 0.01 to 3 μm (for example, filter made of glass fiber or filter made of polypropylene) can be used, for example.

The magnetic layer can be formed through a step of directly applying the composition for forming a magnetic layer onto the non-magnetic support surface or performing multilayer applying of the composition for forming a magnetic layer with the composition for forming a non-magnetic layer sequentially or simultaneously. The back coating layer can be formed through a step of applying a composition for forming a back coating layer onto a surface of the non-magnetic support opposite to the surface having the magnetic layer (or to be provided with the magnetic layer).

After the coating step, various treatments such as a drying treatment, an alignment treatment of the magnetic layer, and a surface smoothing treatment (calendering treatment) can be performed. For the coating step and the various treatments, a well-known technology can be applied, and for example, descriptions disclosed in paragraphs 0051 to 0057 of JP2010-24113A can be referred to. For example, as the alignment treatment, a vertical alignment treatment can be performed. The vertical alignment treatment can be performed by a well-known method such as a method using a polar opposing magnet. In the alignment zone, a drying speed of the coating layer can be controlled depending on a temperature of dry air and an air volume and/or a transportation speed of the magnetic recording medium in the alignment zone. Further, the coating layer may be preliminarily dried before the transportation to the alignment zone.

It is possible to form a servo pattern in the magnetic recording medium manufactured as described above by a well-known method in order to enable tracking control of the magnetic head in the magnetic recording and reproducing device, control of a running speed of the magnetic recording medium, and the like. The term “formation of servo pattern” can also be referred to as “recording of servo signal”. The magnetic recording medium may be a tape-shaped magnetic recording medium (magnetic tape) or may be a disk-shaped magnetic recording medium (magnetic disk). Hereinafter, the formation of the servo patterns will be described using a magnetic tape as an example.

The servo pattern is usually formed along a longitudinal direction of the magnetic tape. Examples of control (servo control) systems using a servo signal include a timing-based servo (TBS), an amplitude servo, and a frequency servo.

As shown in a european computer manufacturers association (ECMA)-319, a magnetic tape conforming to a linear tape-open (LTO) standard (generally referred to as an “LTO tape”) employs a timing-based servo system. In this timing-based servo system, the servo pattern is formed by continuously arranging a plurality of pairs of non-parallel magnetic stripes (also referred to as “servo stripes”) in the longitudinal direction of the magnetic tape. As described above, the reason why the servo pattern is formed of a pair of non-parallel magnetic stripes is to indicate, to a servo signal reading element passing over the servo pattern, a passing position thereof. Specifically, the pair of magnetic stripes is formed such that an interval thereof continuously changes along a width direction of the magnetic tape, and the servo signal reading element reads the interval to thereby sense a relative position between the servo pattern and the servo signal reading element. Information on this relative position enables tracking on a data track. Accordingly, a plurality of servo tracks are usually set on the servo pattern along the width direction of the magnetic tape.

A servo band is formed of a servo signal continuous in the longitudinal direction of the magnetic tape. A plurality of the servo bands are usually provided on the magnetic tape. For example, in an LTO tape, the number of the servo bands is five. Regions interposed between two adjacent servo bands are referred to as data bands. The data band is formed of a plurality of data tracks and each data track corresponds to each servo track.

Further, in one aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

Incidentally, as a method for uniquely specifying the servo band, there is a method using a staggered method as shown in ECMA-319. In this staggered method, a group of pairs of non-parallel magnetic stripes (servo stripes) arranged continuously in plural in a longitudinal direction of the magnetic tape is recorded so as to be shifted in a longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319, information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Note that, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

A head for forming a servo pattern is called a servo write head. The servo write head has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two additional methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where the magnetic pattern is transferred to, using the gap, a magnetic tape that has been subjected to the vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

### Magnetic Tape Cartridge

Another aspect of the present invention relates to a magnetic tape cartridge including the tape-shaped magnetic recording medium (that is, the magnetic tape).

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic recording and reproducing device for recording and/or reproducing data on the magnetic tape, the magnetic tape is pulled out of the magnetic tape cartridge to be wound around the reel on the magnetic recording and reproducing device side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic recording and reproducing device side. During this time, data is recorded and/or reproduced as the magnetic head and the surface on the magnetic layer side of the magnetic tape come into contact with each other to be slid on each other. With respect to this, in the dual reel type magnetic tape cartridge, both reels of the supply reel and the winding reel are provided in the magnetic tape cartridge. The magnetic tape cartridge may be any of single reel type magnetic tape cartridge and dual reel type magnetic tape cartridge. The above magnetic tape cartridge need only include the magnetic tape according to one aspect of the present invention, and the well-known technology can be applied to the others.

### Magnetic Recording and Reproducing Device

Still another aspect of the present invention relates to a magnetic recording and reproducing device including the magnetic recording medium.

In the present invention and the present specification, the term “magnetic recording and reproducing device” means a device capable of performing at least one of the recording of data on the magnetic recording medium or the reproducing of data recorded on the magnetic recording medium. Such a device is generally called a drive. The magnetic recording and reproducing device can be, for example, a sliding type magnetic recording and reproducing device. The sliding type magnetic recording and reproducing device is a device in which the surface on the magnetic layer side and the magnetic head come into contact with each other to be slid on each other, in a case of performing recording of data on the magnetic recording medium and/or reproducing of the recorded data. For example, the magnetic recording and reproducing device can attachably and detachably include the magnetic tape cartridge.

The magnetic recording and reproducing device may include a magnetic head. The magnetic head can be a recording head capable of performing the recording of data on the magnetic recording medium, and can also be a reproducing head capable of performing the reproducing of data recorded on the magnetic recording medium. In addition, in one aspect, the magnetic recording and reproducing device can include both a recording head and a reproducing head as separate magnetic heads. In another aspect, the magnetic head included in the magnetic recording and reproducing device can have a configuration in which both an element for recording data (recording element) and an element for reproducing data (reproducing element) are included in one magnetic head. Hereinafter, the element for recording data and the element for reproducing are collectively referred to as “elements for data”. As the reproducing head, a magnetic head (MR head) including a magnetoresistive (MR) element capable of sensitively reading data recorded on the magnetic recording medium as a reproducing element is preferable. As the MR head, various well-known MR heads such as an Anisotropic Magnetoresistive (AMR) head, a Giant Magnetoresistive (GMR) head, or a Tunnel Magnetoresistive (TMR) head can be used. In addition, the magnetic head which performs the recording of data and/or the reproducing of data may include a servo signal reading element. Alternatively, as a head other than the magnetic head which performs the recording of data and/or the reproduction of data, a magnetic head (servo head) comprising a servo signal reading element may be included in the magnetic recording and reproducing device. For example, a magnetic head that records data and/or reproduces recorded data (hereinafter also referred to as “recording and reproducing head”) can include two servo signal reading elements, and the two servo signal reading elements can simultaneously read two adjacent servo bands. One or a plurality of elements for data can be disposed between the two servo signal reading elements.

In the magnetic recording and reproducing device, recording of data on the magnetic recording medium and/or reproducing of data recorded on the magnetic recording medium can be performed, for example, as the surface of the magnetic recording medium on the magnetic layer side and the magnetic head come into contact with each other to be slid on each other. The magnetic recording and reproducing device need only include the magnetic recording medium according to one aspect of the present invention, and a well-known technology can be applied to the others.

For example, in a case of recording data and/or reproducing recorded data, first, tracking using the servo signal is performed. That is, by causing the servo signal reading element to follow a predetermined servo track, the element for data is controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

### EXAMPLES

Hereinafter, an aspect of the present invention will be described based on Examples. Here, the present invention is not limited to aspects shown in Examples. Unless otherwise noted, “parts” and “%” in the following description indicate “parts by mass” and “mass %”. “eq” is an equivalent and is a unit that cannot be converted into an S1 unit.

The following various steps and operations were performed in an environment of a temperature of 20° C. to 25° C. and a relative humidity of 40% to 60%, unless otherwise noted. Ferromagnetic Powder

In Examples and Comparative Examples, the following hexagonal strontium ferrite was used as the ferromagnetic powder.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the manufactured amorphous body was charged into an electric furnace, was heated to 635° C. (crystallization temperature) at a temperature rising rate of 3.5° C./min, and was kept at the same temperature for 5 hours to precipitate (crystallize) hexagonal strontium ferrite particles.

Next, a crystallized product obtained above and including hexagonal strontium ferrite particles was coarsely pulverized in a mortar, and 1000 g of zirconia beads having a particle diameter of 1 mm and 800 mL of an acetic acid aqueous solution of 1% concentration were added to the crystallized product in a glass bottle containing the pulverized material, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an in-furnace temperature of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10⁵ J/m³, and a mass magnetization σs was 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X'Pert Pro diffractometer, PIXcel detector

Soller slit of incident beam and diffracted beam: 0.017 radians

Fixed angle of dispersion slit: 1/4 degrees

Mask: 10 mm

Anti-scattering slit: 1/4 degrees

Measurement mode: continuous

Measurement time per stage: 3 seconds

Measurement speed: 0.017 degrees per second

Measurement step: 0.05 degrees

### Synthesis Example of Polyalkyleneimine-Based Polymer

Synthesis of Polyester (i-1)

In a 500 mL three-neck flask, 16.8 g of n-octanoic acid (manufactured by FUJIFILM Wako Pure Chemical Corporation) as carboxylic acid, 100 g of ε-caprolactone (PLACCEL M manufactured by Daicel Corporation) as a lactone, 2.2 g of monobutyltin oxide (manufactured by FUJIFILM Wako Pure Chemical Corporation) (C₄H₉Sn(O)OH) as a catalyst were mixed, and the mixture was heated at a temperature of 160° C. for 1 hour. 100 g of &-caprolactone was added dropwise thereto over 5 hours, and the mixture was further stirred for 2 hours. Thereafter, the mixture was cooled to room temperature to obtain polyester (i-1). A number-average molecular weight of the obtained polyester was 5,800. The number of units of the repeating unit of the lactone, which was calculated from a raw material preparation ratio, was 15. The number of units of the lactone repeating unit corresponds to b11 in Formula 1 or b21 in Formula 2.

### Synthesis of Polyalkyleneimine-Based Polymer A

2.4 g of polyethylenimine (SP-006 manufactured by Nippon Shokubai Co., Ltd., number-average molecular weight: 600) and 100 g of the polyester (i-1) were mixed, and the mixed liquid was heated at a temperature of 110° C. for 3 hours to obtain a polyalkyleneimine-based polymer.

The weight-average molecular weight of the obtained polyalkyleneimine-based polymer was 7,000. For the obtained polyalkyleneimine-based polymer, a proportion of the polyalkyleneimine chain in the polyalkyleneimine-based polymer (polyalkyleneimine chain ratio) was calculated to be 2.3% by mass from NMR analysis results of both 1H-NMR and 13C-NMR and analysis results of elemental analysis using a combustion method. The calculated polyalkyleneimine chain ratio was the same value as a value calculated from the charged amount of polyalkyleneimine and polyester. From the NMR analysis results of both 1H-NMR and 13C-NMR, it was confirmed that a polymer having a structure having the following repeating units was obtained.

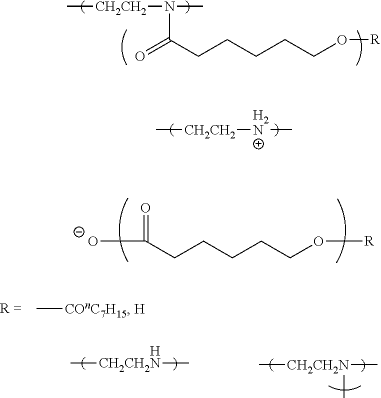

The number-average molecular weight and the weight-average molecular weight are values measured by a GPC method and obtained by standard polystyrene conversion.

Measurement conditions for the average molecular weight of the polyester, polyalkyleneimine (polyethyleneimine), and polyalkyleneimine-based polymer were as follows.

### Measurement Conditions for Number-Average Molecular Weight of Polyester

Measuring instrument: HLC-8220 GPC (manufactured by Tosoh Corporation)

Column: TSKgel Super HZ 2000/TSKgel Super HZ 4000/TSKgel Super HZ-H

(manufactured by Tosoh Corporation)

Eluent: tetrahydrofuran (THF)

Flow rate: 0.35 mL/min

Column temperature: 40° C.

Detector: Differential refractive index (RI) detector

### Measurement Conditions for Number-Average Molecular Weight of Polyalkyleneimine and Weight-Average Molecular Weight of Polyalkyleneimine-Based Polymer

Measuring instrument: HLC-8320 GPC (manufactured by Tosoh Corporation)

Column: 3 pieces of TSKgel Super AWM-H (manufactured by Tosoh Corporation)

Eluent: N-methyl-2-pyrrolidone (added 10 mM lithium bromide as an additive)

Flow rate: 0.35 mL/min

Column temperature: 40° C.

Detector: RI

### Synthesis Example of Fluorine-Based Nitrogen-Containing Polymer

Synthesis of Polymer 1

6 g of the polyalkyleneimine-based polymer synthesized above and 20 g of methyl ethyl ketone (MEK) were added to a 100 mL three-neck flask and dissolved at a liquid temperature of 40° C. After cooling to room temperature, 7.94 g of methyl trifluorodecaheptanoate was added thereto, and the mixture was stirred at room temperature for 1 hour. A reaction solution was added dropwise to 200 mL of hexane and then reprecipitated to obtain 5.4 g of a polymer 1. Using 1H-NMR and 19F-NMR and 2,2-bis (4-hydroxyphenyl) hexafluoropropane as an internal standard, it was confirmed that a polymer having a structure having the following repeating units was obtained.

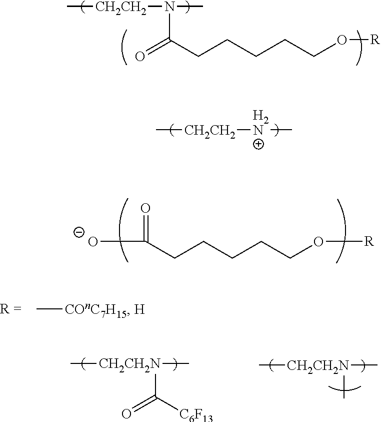

### Synthesis Method of Polymer 2

5.2 g of a polymer 2 was obtained by the same procedure except that methyl trifluorodecaheptanoate in the synthesis of the polymer 1 was replaced with 5.85 g of methyl nonafluoropentanoate. Using H-NMR and 19F-NMR and 2,2-bis (4-hydroxyphenyl) hexafluoropropane as an internal standard, it was confirmed that a polymer having a structure having the following repeating units was obtained.

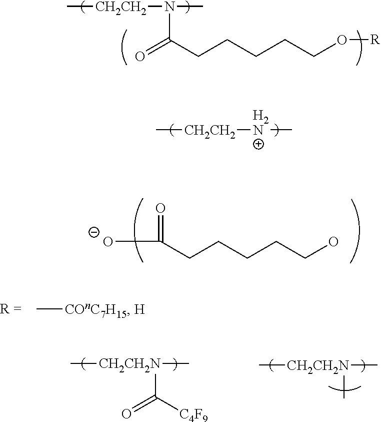

Synthesis Method of Polymer 3

4.8 g of a polymer 3 was obtained by the same procedure except that methyl trifluorodecaheptanoate in the synthesis of the polymer 1 was replaced with 5.48 g of nonafluorobutyl isocyanate. Using H-NMR and 19F-NMR and 2,2-bis (4-hydroxyphenyl) hexafluoropropane as an internal standard, it was confirmed that a polymer having a structure having the following repeating units was obtained.

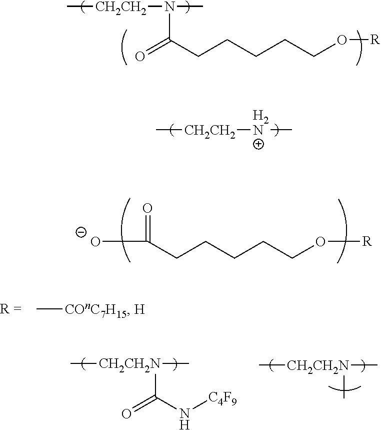

### Example 1

### Preparation of Composition for Forming Magnetic Layer

The following components were kneaded with an open kneader and then dispersed using a sand mill.

Ferromagnetic powder: 100.0 parts

Polyalkyleneimine-based polymer A: see Table 1

Polyurethane resin: (VYLON (registered trademark) UR4800, manufactured by Toyobo Co., Ltd., functional group: SO₃N₄, functional group concentration: 70 eq/ton): 4.0 parts

Vinyl chloride resin (MR104 manufactured by Kaneka Corporation): 10.0 parts

Methyl ethyl ketone: 150.0 parts

Cyclohexanone: 150.0 parts

α-Al₂O₃ (average particle size: 0.1 μm): 6.0 parts

Carbon black (average particle size: 20 nm): 0.7 parts

The following components were added to the dispersion liquid obtained above, and the mixture was stirred and then subjected to an ultrasonic treatment, and filtered using a filter having a pore diameter of 1 μm, thereby preparing a composition for forming a magnetic layer.

Fluorine-based nitrogen-containing polymer (see Table 1 for type and addition amount)

Stearic acid: 1.5 parts

Butyl stearate: 0.5 parts

Stearic acid amide: 0.3 parts

Methyl ethyl ketone: 110.0 parts

Cyclohexanone: 110.0 parts

Polyisocyanate compound (CORONATE 3041 manufactured by Tosoh Corporation): 3.0 parts

### Preparation of Composition for Forming Non-Magnetic Layer

The following components were kneaded with an open kneader and then dispersed using a sand mill. The obtained dispersion liquid was filtered using a filter having a pore diameter of 1 μm to prepare a composition for forming a non-magnetic layer.

Carbon black: 100.0 parts

Dibutyl phthalate (DBP) oil absorption: 100 mL/100 g

pH: 8

Brunauer-emmett-teller (BET) specific surface area: 250 m²/g

Volatile content percentage: 1.5%

Polyurethane resin (VYLON UR4800, manufactured by Toyobo Co., Ltd., functional group: SO₃Na, functional group concentration: 70 eq/ton): 20.0 parts

Vinyl chloride resin (functional group: OSO₃K, functional group concentration: 70 eq/ton): 30.0 parts

Trioctylamine: 4.0 parts

Cyclohexanone: 140.0 parts

Methyl ethyl ketone: 170.0 parts

Stearic acid amide: 0.3 parts

Toluene: 3.0 parts

Polyisocyanate compound (CORONATE 3041 manufactured by Tosoh Corporation): 5.0 parts

### Preparation of Composition for Forming Back Coating Layer

The following components were pre-kneaded with a roll mill and then dispersed with a sand mill. To the obtained dispersion liquid, 4.0 parts of a polyester resin (VYLON500 manufactured by Toyobo Co., Ltd.), 14.0 parts of a polyisocyanate compound (CORONATE 3041 manufactured by Tosoh Corporation), and 5.0 parts of α-Al₂O₃ (manufactured by Sumitomo Chemical Co., Ltd.) were added and stirred, and then filtered, thereby preparing a composition for forming a back coating layer.

Carbon black (average particle size: 40 nm): 85.0 parts

Carbon black (average particle size: 100 nm): 3.0 parts

Nitrocellulose: 28.0 parts

Polyurethane resin: 58.0 parts

Copper phthalocyanine-based dispersing agent: 2.5 parts

NIPPOLLAN 2301 (manufactured by Tosoh Corporation.): 0.5 parts

Methyl isobutyl ketone: 0.3 parts

Methyl ethyl ketone: 860.0 parts

Toluene: 240.0 parts

### Manufacture of Magnetic Recording Medium

Both surfaces of a biaxially stretched polyethylene naphthalate support having a thickness of 5.0 μm were subjected to a corona discharge treatment.

The composition for forming a non-magnetic layer was applied onto one surface of the polyethylene naphthalate support such that the thickness of the non-magnetic layer after drying was 1.0 μm, and immediately after that, the composition for forming a magnetic layer was applied thereonto such that the thickness of the magnetic layer after drying was 100 nm. After performing a vertical alignment treatment using a cobalt magnet having a magnetic force of 0.5 T (tesla) and a solenoid having a magnetic force of 0.4 T while both layers were in a wet state, a drying treatment was performed. Thereafter, the composition for forming a back coating layer was applied onto the other surface of the polyethylene naphthalate support such that the thickness of the back coating layer after drying was 0.5 μm, and then a calendering treatment was performed at a surface temperature of a calender roll of 100° C. and a speed of 80 m/min with a 7-stage calender configured of metal rolls. Thereafter, the layer was slit to have a width of ½ inches (1 inch is 0.0254 meters) to manufacture a magnetic tape.

### Examples 2 to 4 and Comparative Example 1

A magnetic tape was manufactured by the method described in Example 1 except that various items were changed as shown in Table 1.

### Examples 5 to 11

A magnetic tape was manufactured by the method described in Example 1, except that the composition for forming a magnetic layer was prepared by the method described below.

### Preparation of Composition for Forming Magnetic Layer

The following components were kneaded with an open kneader and then dispersed using a sand mill.

Ferromagnetic powder: 100.0 parts

Polyalkyleneimine-based polymer A: see Table 1

Fluorine-based nitrogen-containing polymer (see Table 1 for type and addition amount)

Polyurethane resin: (VYLON (registered trademark) UR4800, manufactured by Toyobo Co., Ltd., functional group: SO₃Na, functional group concentration: 70 eq/ton): 4.0 parts

Vinyl chloride resin (MR104 manufactured by Kaneka Corporation): 10.0 parts

Methyl ethyl ketone: 150.0 parts

Cyclohexanone: 150.0 parts

α-Al₂O₃ (average particle size: 0.1 μm): 6.0 parts Carbon black (average particle size: 20 nm): 0.7 parts

The following components were added to the dispersion liquid obtained above, and the mixture was stirred and then subjected to an ultrasonic treatment, and filtered using a filter having a pore diameter of 1 μm, thereby preparing a composition for forming a magnetic layer.

Stearic acid: 1.5 parts

Butyl stearate: 0.5 parts

Stearic acid amide: 0.3 parts

Methyl ethyl ketone: 110.0 parts

Cyclohexanone: 110.0 parts

Polyisocyanate compound (CORONATE 3041 manufactured by Tosoh Corporation): 3.0 parts

### Examples 12 and 13 and Comparative Example 2

A magnetic tape was manufactured by the method described in Example 1, except that the composition for forming a magnetic layer was prepared by the method described below.

### Preparation of Composition for Forming Magnetic Layer

The following components were kneaded with an open kneader and then dispersed using a sand mill.

Ferromagnetic powder: 100.0 parts

Polyalkyleneimine-based polymer A: see Table 1

Polyurethane resin: (VYLON (registered trademark) UR4800, manufactured by Toyobo Co., Ltd., functional group: SO₃Na, functional group concentration: 70 eq/ton): 4.0 parts

Vinyl chloride resin (MR104 manufactured by Kaneka Corporation): 10.0 parts

Methyl ethyl ketone: 150.0 parts

Cyclohexanone: 150.0 parts

α-Al₂O₃ (average particle size: 0.1 μm): 6.0 parts

Carbon black (average particle size: 20 nm): 0.7 parts

The following components were added to the dispersion liquid obtained above, and the mixture was stirred and then subjected to an ultrasonic treatment, and filtered using a filter having a pore diameter of 1 μm, thereby preparing a composition for forming a magnetic layer.

Fluorine-containing compound (see Table 1 for type and addition amount)

Stearic acid: 1.5 parts

Butyl stearate: 0.5 parts

Stearic acid amide: 0.3 parts

Methyl ethyl ketone: 110.0 parts

Cyclohexanone: 110.0 parts

Polyisocyanate compound (CORONATE 3041 manufactured by Tosoh Corporation): 3.0 parts

For each of the magnetic tape of Example 12, the magnetic tape of Example 13, and the magnetic tape of Comparative Example 2, a sample piece having a length of 30 cm was cut out from the magnetic tape. The cut-out sample piece was placed on a petri dish, and the entire sample piece was immersed in 10 mL of tetrahydrofuran (THF) for 1 hour to perform an extraction treatment. The THF after the extraction treatment was transferred to a 50 mL one-neck eggplant flask, distilled off using an evaporator, and then dried under reduced pressure. Using 1H-NMR and 19F-NMR and 2,2-bis (4-hydroxyphenyl) hexafluoropropane as an internal standard, it was confirmed that a polymer in which a fluorine-containing group of the fluorine-containing compound and a fluorine atom of the polyalkyleneimine-based polymer A were bonded was present.

### Evaluation Method

Contact Angle After Hexane Cleaning

For each of the magnetic tapes of Examples and Comparative Examples, the contact angle after hexane cleaning was obtained by the method described above.

Specifically, the contact angle after hexane cleaning was obtained as follows.

A sample piece having a length of 30 cm was cut out from each of the magnetic tapes of Examples and Comparative Examples. The cut-out sample piece was placed on a petri dish, and the entire sample piece was immersed in 10 mL of fresh hexane. After 1 hour, the sample piece was taken out from the hexane and naturally dried at room temperature for 24 hours or longer.

After the hexane cleaning, the contact angle of the magnetic layer surface of the sample piece with respect to water was measured by a contact angle measuring device (contact angle measuring device DropMaster 700 manufactured by Kyowa Interface Science Co., Ltd.) by the following method. The contact angle was measured in a measurement environment of an atmosphere temperature of 20° C. and a relative humidity of 25%.

The sample piece was placed on a slide glass such that the back coating layer surface was in contact with the slide glass surface. 2.0 μL of a measurement liquid (water) was added dropwise onto the surface of the sample piece (magnetic layer surface), and after visually confirming that the added liquid formed stable liquid droplets, a liquid droplet image was analyzed by a contact angle analysis software FAMAS attached to the contact angle measuring device, and the contact angle of the liquid droplet with the sample piece was measured. The contact angle was calculated by a 0/2 method. The measurement point was set to six points randomly selected on the magnetic layer surface, and the contact angle was measured at each of the six points. An arithmetic average of the six measured values obtained as described above was defined as a contact angle after hexane cleaning of the magnetic tape to be measured.

Method: liquid droplet method (0/2 method)

Droplet landing recognition: automatic

Droplet landing recognition line (distance from needle tip): 50 dots

Algorithm: automatic

Image mode: frame

Threshold hold level: automatic

### Frictional Property

In an environment controlled to an atmosphere temperature of 13° C. and a relative humidity of 80%, a magnetic head detached from a linear tape-open generation 7 (LTO (registered trademark) G7) drive manufactured by IBM Corporation was attached to a tape running system, and a magnetic tape having a tape length of 20 m was run at 4.0 m/see for 10000 cycles while performing feeding from a feeding roll and winding around a winding roll with an applied tension of 0.6 N.

In the first cycle of running and the 10000th cycle of running, the frictional force applied to the magnetic head during running was measured using a strain gauge, and the friction coefficient u value was obtained from the measured frictional force. The friction coefficient after repeated running was evaluated from the measured u value according to the following evaluation standard. Evaluation results A or B are preferable, and A is most preferable.

Evaluation Standard

A: μ value was less than 0.08.

B: μ value was 0.08 or more and 0.12 or less.

C: μ value was more than 0.12.

### Abrasiveness

In an environment controlled to an atmosphere temperature of 23° C. and a relative humidity of 50%, the magnetic layer surface of the unrunning magnetic tape was brought into contact with one edge side (edge) of an AlFeSil square bar at a wrap angle of 12 degrees so as to be orthogonal to a longitudinal direction of the AlFeSil square bar (square bar specified in European Computer Manufacturers Association (ECMA)-288/Annex H/H2), and in this state, the magnetic tape having a length of 580 m was reciprocated 50 times at a speed of 3 m/see under a tension of 1.0 N. The AlFeSil square bar is a square bar made of AlFeSil, which is a Sendust-based alloy.

An edge of the square bar was observed from above using an optical microscope to obtain an abrasion width (AlFeSil abrasion width) described in a paragraph 0015 of JP2007-026564A, based on FIG. 1 of the same publication. The abrasiveness of the magnetic layer surface was evaluated from the obtained abrasion width according to the following evaluation standard. A unit of the abrasion width is μm. Evaluation results A or B are preferable, and A is most preferable.

A: The abrasion width was 15 or more and less than 25.

B: The abrasion width was 25 or more and 40 or less.

C: The abrasion width was less than 15 or more than 40.

### Reduction Rate of 5 nm Protrusion (Evaluation of Change in Surface Shape of Magnetic Layer Before and After Repeated Running)

For each of the magnetic tapes of Examples and Comparative Examples, the number of protrusions having a height of 5 nm or more on the magnetic layer surface was obtained by the following method for the unrunning magnetic tape and the magnetic tape after the repeated running in the above environment.

The number of protrusions having a height of 5 nm or more was obtained by measurement using an atomic force microscope (AFM). Specifically, in a plane image of the magnetic layer surface obtained using the AFM, a plane where a volume of protruding components and a volume of recess components in the measurement region are equal to each other was defined as a reference plane, and the number of protrusions having a height of 5 nm or more from the reference plane was obtained. Among the protrusions which have a height of 5 nm or more and are present in the measurement region, there may be protrusions of which a part is inside the measurement region and the other part is outside the measurement region. In a case of obtaining the number of protrusions, the number of protrusions was measured including such protrusions.

The measurement region in the measurement using the AFM was taken as a region of 5 μm square (5 μm×5 μm) on the magnetic layer surface. The measurement was performed for three different measurement regions on the magnetic layer surface (n=3). The number of protrusions having a height of 5 nm or more was obtained as an arithmetic average of three values obtained through such measurement. The following measurement conditions were employed as measurement conditions of the AFM.

A region of 5 μm square (5 μm×5 μm) on the surface of the magnetic layer of the magnetic tape was measured using an AFM (Nanoscope 4 manufactured by Veeco Instruments, Inc.) in a tapping mode. RTESP-300 manufactured by BRUKER was used as a probe, a resolution was set to 512 pixels×512 pixels, and a scan speed was set to a speed at which one screen (512 pixels×512 pixels) was measured in 341 seconds.

The change in surface shape of the magnetic layer before and after the repeated running was evaluated according to the following evaluation standard from the protrusion reduction rate calculated by the following expression. It can be determined that, as the value of the protrusion reduction rate is smaller, the change in surface shape of the magnetic layer before and after the repeated running is suppressed.

Protrusion reduction rate (%)=[(number of protrusions obtained for unrunning magnetic tape)−(number of protrusions obtained for magnetic tape after the above-described repeated running)/(number of protrusions obtained for unrunning magnetic tape)]×100Evaluation Standard

A: The protrusion reduction rate was 40% or less.

B: The protrusion reduction rate was more than 40% and less than 70%.

C: The protrusion reduction rate was 70% or more.

### Dispersibility

For each of Examples and Comparative Examples, a sample solution was prepared by taking a portion of the composition for forming a magnetic layer prepared above and diluting it to 1/50 on a mass basis with an organic solvent used to prepare this composition. For this sample solution, an arithmetic average particle diameter measured using a light scattering-type particle size distribution diameter (LB500 manufactured by HORIBA) was defined as the dispersed particle diameter. The dispersibility was evaluated according to the following evaluation standard. It can be determined that the smaller the value of the dispersed particle diameter, the more excellent the dispersibility of the ferromagnetic powder in the composition for forming a magnetic layer.

### Evaluation Standard

A: The dispersed particle diameter was 25 nm or less.

B: The dispersed particle diameter was more than 25 nm and less than 40 nm.

C: The dispersed particle diameter was 40 nm or more.

The above-described evaluation results are shown in Table 1.

TABLE 1

| | | | | | | | | | Contact | | | |
|---|---|---|---|---|---|---|---|---|---|---|---|---|
| | | | Fluorine-based nitrogen- | | | Fluorine-containing | | | angle | | | |
| | Polyalkyleneimine- | | containing polymer | | | compound | | | after | | | Reduction |
| | based polymer A | | | Addition | | | Addition | Dispers- | hexane | Frictional | Abra- | rate of 5 |
| | Addition amount | | Type | amount | | Type | amount | ibility | cleaning | Properties | siveness | protrusion |
| Example 1 | 10.0 | parts | Polymer 1 | 0.5 | parts | None | — | A | 90° | A | A | A 30% |
| Example 2 | 10.0 | parts | Polymer 1 | 1.0 | part | None | — | A | 101° | A | A | A 30% |
| Example 3 | 10.0 | parts | Polymer 1 | 5.0 | parts | None | — | A | 105° | A | A | A 25% |
| Example 4 | 10.0 | parts | Polymer 1 | 10.0 | parts | None | — | A | 110° | A | A | A 20% |
| Example 5 | 5.0 | parts | Polymer 1 | 5.0 | parts | None | — | A | 105° | A | A | A 20% |
| Example 6 | 7.0 | parts | Polymer 2 | 3.0 | parts | None | — | A | 102° | A | A | A 30% |
| Example 7 | 5.0 | parts | Polymer 2 | 5.0 | parts | None | — | A | 105° | A | A | A 25% |
| Example 9 | 2.0 | parts | Polymer 2 | 8.0 | parts | None | — | A | 108° | A | A | A 20% |
| Example 10 | 0 | parts | Polymer 2 | 10.0 | parts | None | — | A | 110° | A | A | A 30% |
| Example 11 | 5.0 | parts | Polymer 3 | 5.0 | parts | None | — | A | 105° | A | A | A 25% |

| Example 12 | 10.0 | parts | None | — | C₆F₁₃COOCH₃ | 10.0 | parts | A | 100° | A | A | A 20% |
|---|---|---|---|---|---|---|---|---|---|---|---|---|
| Example 13 | 10.0 | parts | None | — | C₄F₉COOCH₃ | 10.0 | parts | A | 90° | A | A | A 30% |
| Comparative | 10.0 | parts | None | — | None | — | | A | 80° | C | C | C 70% |
| Example 1 | | | | | | | | | | | | |
| Comparative | 10.0 | parts | None | — | C₆F₁₃COOCH₃ | 0.5 | parts | A | 85° | C | C | B 50% |
| Example 2 | | | | | | | | | | | | |

From the results shown in Table 1, it can be confirmed that the magnetic tapes of Examples 1 to 13 have a magnetic layer surface having appropriate abrasiveness, have a low friction coefficient even after the repeated running, and have a small change in surface shape of the magnetic layer before and after the repeated running.

In addition, for the evaluation results of the dispersibility shown in Table 1, for example, in a case where Example 1 and Examples 5 to 11 are compared, the evaluation result of the dispersibility was A as in Example 1 even in Examples 5 to 11 in which the addition amount of the polyalkyleneimine-based polymer A was smaller than that of Example 1. From this result, it can be confirmed that the fluorine-based nitrogen-containing polymers 1 to 3 contributed to the improvement of the dispersibility as with the polyalkyleneimine-based polymer A.

An aspect of the present invention is useful in the technical field of a magnetic recording medium for high density recording.

What is claimed is:

1. A magnetic recording medium comprising:
a non-magnetic support; and
a magnetic layer containing a ferromagnetic powder,
wherein a nitrogen-containing polymer is included in a portion on the non-magnetic support on a magnetic layer side,
the nitrogen-containing polymer contains a fluorine-containing group and a polyester chain,
the fluorine-containing group is bonded to a nitrogen atom of the nitrogen-containing polymer,
the polyester chain is bonded to the nitrogen atom of the nitrogen-containing polymer or forms a salt crosslinking structure with the nitrogen atom of the nitrogen-containing polymer, and
a contact angle with water, which is measured on a surface of the magnetic layer after hexane cleaning, is 90° or more.

2. The magnetic recording medium according to claim 1,
wherein the nitrogen-containing polymer is a polyalkyleneimine-based polymer.

3. The magnetic recording medium according to claim 1,
wherein the fluorine-containing group includes a group selected from the group consisting of a fluorinated alkyl group and a perfluoropolyether group.

4. The magnetic recording medium according to claim 2,
wherein the fluorine-containing group includes a group selected from the group consisting of a fluorinated alkyl group and a perfluoropolyether group.

5. The magnetic recording medium according to claim 3,
wherein the fluorinated alkyl group is a fluorinated alkyl group having 1 or more and 6 or less carbon atoms.

6. The magnetic recording medium according to claim 4,
wherein the fluorinated alkyl group is a fluorinated alkyl group having 1 or more and 6 or less carbon atoms.

7. The magnetic recording medium according to claim 1,
wherein the contact angle is 90° or more and 110° or less.

8. The magnetic recording medium according to claim 1,
wherein the portion on the non-magnetic support on a magnetic layer side further includes one or more fatty acid compounds selected from the group consisting of a fatty acid, a fatty acid ester, and a fatty acid amide.

9. The magnetic recording medium according to claim 1,
wherein the portion on the non-magnetic support on a magnetic layer side further includes a nitrogen-containing polymer other than the nitrogen-containing polymer.

10. The magnetic recording medium according to claim 1, further comprising:
a non-magnetic layer containing a non-magnetic powder between the non-magnetic support and the magnetic layer.

11. The magnetic recording medium according to claim 1, further comprising:
a back coating layer containing a non-magnetic powder on a surface side of the non-magnetic support opposite to a surface side having the magnetic layer.

12. The magnetic recording medium according to claim 1,
wherein the magnetic recording medium is a magnetic tape.

13. The magnetic recording medium according to claim 1,
wherein the nitrogen-containing polymer is a polyalkyleneimine-based polymer,
the fluorine-containing group includes a group selected from the group consisting of a fluorinated alkyl group and a perfluoropolyether group,
the fluorinated alkyl group is a fluorinated alkyl group having 1 or more and 6 or less carbon atoms,
the contact angle is 90° or more and 110° or less,
the portion on the non-magnetic support on a magnetic layer side further includes one or more fatty acid compounds selected from the group consisting of a fatty acid, a fatty acid ester, and a fatty acid amide, and a nitrogen-containing polymer other than the nitrogen-containing polymer,
the magnetic recording medium further includes
a non-magnetic layer containing a non-magnetic powder between the non-magnetic support and the magnetic layer, and
a back coating layer containing a non-magnetic powder on a surface side of the non-magnetic support opposite to a surface side having the magnetic layer, and
the magnetic recording medium is a magnetic tape.

14. A magnetic tape cartridge comprising:
the magnetic tape according to claim 12.

15. A magnetic recording and reproducing device comprising:
the magnetic recording medium according to claim 1.
